(19) United States
(12) Patent Application Publication
(10) Pub. No.: US 2006/0085978 A1
(43) Pub. Date: Apr. 27, 2006

(54) Turbine component fixture for manufacture or repair

(76) Inventor: Thomas H. Milidantri JR., Goshen, NY (US)

Correspondence Address: MITCHELL D. BITTMAN, SEQUA CORPORATION, 3 UNIVERSITY PLAZA, HACKENSACK, NJ, 07601, US

(21) Appl. No.: 10/970,560

(22) Filed: Oct. 21, 2004

(51) Int. Cl. B23P 6/00

(52) U.S. Cl. 29/889.1; 29/402.01; 29/402.19; 29/889.2; 29/889.23

(57) ABSTRACT

A process is provided for manufacturing or repairing a turbine component, wherein the component has an internal cavity open to the outside, by inserting into the internal cavity a part of a fixture, with the part secured to the internal surface of the internal cavity of the component to hold the component and carrying out a manufacturing or repair process on an exterior surface of the turbine component.

### BACKGROUND

This invention relates to a workpiece holder, and more particularly to holding a turbine component during a manufacturing or repair process.

High pressure turbine airfoils are cast from cobalt or nickel superalloys and are hollow for air-cooling benefits and to reduce weight. One technique used in the repair of these components after in flight service is to diffusion braze whereby wall dimensions are restored or cooling holes re-dimensioned. The brazing process leaves excess material, extremely hard in nature, on the gas path surface of the airfoil. In addition, during service the airfoil may have changed shape or may have been damaged by foreign objects necessitating a blending operation to re-contour the airfoil to its original configuration.

Blending is typically a manual operation but can be performed on a robotic device. When performed manually the re-contour configuration depends upon the eye/hand coordination of the operator to approximate the airfoil shape. The problem is compounded because the component is manually held, i.e., fixtured. Automated blending, when available, is not much better as the components are fixtured by exerting pressure on various external features. These external features are frequently distorted during service which prevents accurate positioning. Additionally, the external features of each component distort differently resulting in poor repeatability from component to component. Therefore, the current blending techniques are more of an art than a science.

### SUMMARY

A process is provided for manufacturing or repairing a turbine component, wherein the component has an internal cavity open to the outside, by inserting into the internal cavity a part of a fixture, with the part secured to the internal surface of the internal cavity of the component to hold the component and carrying out a manufacturing or repair process on an exterior surface of the turbine component.

### BRIEF DESCRIPTION OF THE DRAWINGS

FIG. 1 is a top view of one embodiment of the fixture of this invention.

FIG. 2 is a side view of a turbine component.

FIG. 3 is a top view of the fixture inserted into and holding the component.

### DETAILED DESCRIPTION

This invention eliminates the inaccuracies of fixturing which relies on external features of a turbine component by holding the turbine component by its internal surfaces. As the internal surfaces are not affected by engine operation component to component repeatability is assured. In addition, with automated equipment, various manufacturing or repair process programs can be designed that define the external configuration relative to the internal surfaces. This is a superior approach to the current techniques where the external surface is re-contoured to the correct external shape, but the relationship to the internal surface is ignored.

The staging system holds the turbine component in place in a manner that is repeatable from component to component and is independent of configuration changes resulting from service. An additional benefit is that by staging a part from the inside there is no interference between the fixture and the manufacturing or repair process.

The turbine component which can be repaired by this invention has an internal cavity which is open to the outside to allow for insertion of a part of a fixture, which part is secured to the internal surface of the internal cavity of the component. A suitable turbine component is a high pressure turbine component, particularly an airfoil, which is hollow to increase cooling and reduce weight. By holding the component by its internal surfaces accurate fixturing and repeatability from component to component is obtained.

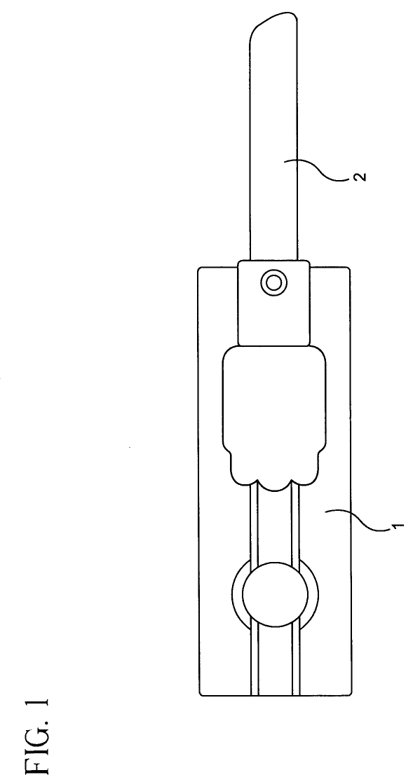

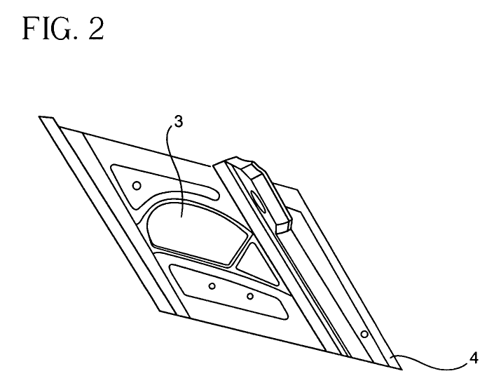

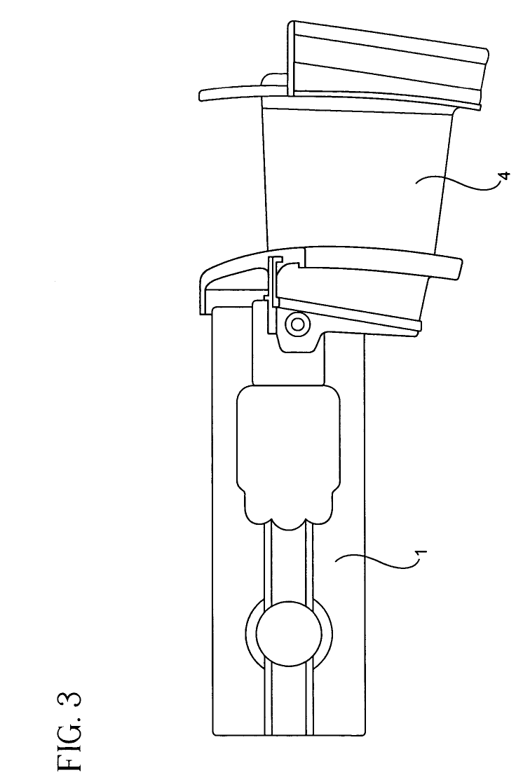

FIG. 1 shows an embodiment, with the fixture 1 having a part 2 with a shape that corresponds to the internal surface of the internal cavity 3 of the airfoil 4 shown in FIG. 2. FIG. 3 shows the fixture 1 holding the airfoil 4 after insertion of the part 2 into the internal cavity 3. The fixture 1 can be readily formed by casting.

The fixture can also include a locking mechanism to lock the component onto the fixture. This can be, for example, a bolt which screws into the part of the fixture through an opening in the component or having a part which can be expanded or rotated to grip the internal surface of the component. Other suitable locking mechanisms could also be used to secure the component onto the fixture.

With the component held by the fixture a variety of manufacturing or repair processes can be carried out on the external surface of the component including, but no limited to, machining, blending, gritting, surface finishing, welding, drilling, cutting, coating and inspecting. These processes can be carried out on the component without the interference of a fixture gripping an external feature and with highly accurate and repeatable positioning of the component, independent of any damage to or distortion of the external features caused during service. Advantageously, these processes can be carried out using automated or robotic equipment which can use preset process parameters based on the preprogrammed designs and specifications of the component.

What is claimed is:

1. A process for manufacturing or repairing a turbine component, wherein the component has an internal cavity open to the outside comprising:
inserting into the internal cavity a part of a fixture, with the part secured to an internal surface of the internal cavity of the component to hold the turbine component; and
carrying out the manufacturing or repair process on an exterior surface of the turbine component.

2. Process of claim 1 wherein the turbine component is a turbine airfoil.

3. Process of claim 2 wherein the part has a shape that corresponds to the internal surface of the turbine airfoil internal cavity.

4. Process of claim 3 wherein the manufacturing or repair process carried out on the airfoil is selected from the group consisting of machining, blending, gritting, surface finishing, welding, drilling, cutting, coating and inspecting.

5. Process of claim 4 wherein the fixture further includes a locking mechanism which locks the component onto the fixture.

6. Process of claim 4 wherein the manufacturing or repair process is carried out with an automated equipment utilizing preset process parameters based on a preprogrammed design and specification of the component.

7. Process of claim 6 wherein the manufacturing or repair process is a repair process.

8. A turbine component holder for securing a component during a manufacturing or repair process wherein the component has an internal cavity open to the outside comprising:
a fixture having a part which is secured to the internal surface of the internal cavity of the component.

9. Holder of claim 8 wherein the part has a shape that corresponds to an internal surface of the internal cavity.

10. Holder of claim 9 wherein the fixture further includes a locking mechanism which locks the component onto the fixture.

11. Holder of claim 9 wherein the part has a shape which corresponds to the internal surface of an airfoil.
